(19) United States
(12) Patent Application Publication
(10) Pub. No.: US 2024/0003806 A1
(43) Pub. Date: Jan. 4, 2024

(54) SYSTEM AND METHOD FOR EXTRACTING AND DETECTING A PARAMAGNETIC MATERIAL FROM AN AQUEOUS MEDIUM

(71) Applicant: Chromologic LLC, Monrovia, CA (US)

(72) Inventors: Espoir KYUBWA, Pasadena, CA (US); Johnathan KNECHT, Rancho Cucamonga, CA (US); Robert CARTLAND, Alhambra, CA (US); Dmitriy ZHUKOV, Baldwin Park, CA (US); Naresh MENON, La Canada Flintridge, CA (US)

(21) Appl. No.: 18/036,129

(22) PCT Filed: Nov. 9, 2021
(86) PCT No.: PCT/US21/58664

§ 371 Date: May 9, 2023

Related U.S. Application Data
(60) Provisional application No. 63/112,117, filed on Nov. 10, 2020.

(51) Int. Cl. G01N 21/17; G01N 21/59; G01N 1/40

(52) U.S. Cl. CPC G01N 21/1717; G01N 21/59; G01N 1/4055; G01N 2021/1727; G01N 2001/4061

(57) ABSTRACT

A method of extracting and detecting paramagnetic material in an aqueous medium, the method including: loading a sample into a holder in a cavity enhancement module; directing light from a light source to the sample in the holder; applying an oscillating magnetic field to the sample in the holder; determining a first level of transmittance with the oscillating magnetic field in a first state; determining a second level of transmittance with the oscillating magnetic field in the second state; and determining a change in transmittance of the light from the sample based on the first level of transmittance and the second level of transmittance.

### CROSS-REFERENCE TO RELATED APPLICATION

This application is a U.S. National Phase Patent Application of International Application Number PCT/US2021/058664 filed on Nov. 9, 2021, which claims priority to and the benefit of U.S. Provisional Application No. 63/112,117, filed on Nov. 10, 2020, entitled “A mobile enabled high-throughput point-of-care diagnostic device for malaria achieves limit of detection in the pre-symptomatic parasitemia levels” the entire disclosure of each of which is incorporated by reference herein.

### STATEMENT REGARDING FEDERALLY SPONSORED RESEARCH OR DEVELOPMENT

This invention was made with U.S. Government support under Contract awarded by the National Institute of Allergy and Infectious Diseases of the National Institute of Health. The U.S. Government has certain rights to this invention.

### BACKGROUND

### 1. Field

Aspects of some embodiments of the present disclosure relate to a system and method for extracting and detecting a paramagnetic material from an aqueous medium.

### 2. Description of Related Art

Generally, paramagnetic materials have a small, positive susceptibility to magnetic fields and may be weakly attracted by an external magnetic field. These paramagnetic materials may not retain their magnetic properties when the external magnetic field is removed. Accordingly, research has been conducted into methods and systems of exploiting the properties of paramagnetic materials.

Malaria, an insect-borne disease, is a problem that threatens world health and economic development. Malaria may cause fever, tiredness, vomiting, headaches, jaundice, seizures, coma, and/or death with symptoms beginning ten to fifteen days after receiving malaria parasites from an infected mosquito. Some 500 million clinical cases and more than one million deaths are caused by malaria per year, and areas dealing with malaria outbreaks encounter increased healthcare costs, loss of ability to work, and adverse effects on tourism. Accordingly, surveillance technology that can help reduce the spread of malaria infections and total malaria burden are important tools for combating the threat posed by malaria.

The above information disclosed in this Background section is for enhancement of understanding of the background of the present disclosure, and therefore, it may contain information that does not constitute prior art.

### SUMMARY

Aspects of one or more embodiments of the present disclosure are directed toward a system and method for extracting and detecting paramagnetic materials in an aqueous medium. For example, aspects of one or more embodiments of the present disclosure are directed toward a system and method of extracting paramagnetic materials from an aqueous medium to be analyzed by exploiting magnetic and optical properties of the paramagnetic materials.

Aspects of one or more embodiments of the present disclosure are directed toward a system and method of extracting and detecting hemozoin in whole blood (e.g., 1 blood drawn from the body without removal of components such as platelets, plasma, and red and white blood cells) to provide a highly sensitive and rapid point-of-care (POC) diagnostic test that serves as a malaria screening tool in low resource settings (LRS).

According to one or more embodiments of the present disclosure, there is provided a method of detecting paramagnetic material in an aqueous medium, the method including: loading a sample into a holder in a cavity enhancement module; directing light from a light source to the sample in the holder; applying an oscillating magnetic field to the sample in the holder; determining a first level of transmittance with the oscillating magnetic field in a first state; changing a state of the oscillating magnetic field from the first state to a second state; determining a second level of transmittance with the oscillating magnetic field in the second state; and determining a change in transmittance of the light from the sample based on the first level of transmittance and the second level of transmittance.

In one or more embodiments, the holder may be between a first magnet and a second magnet configured to apply the oscillating magnetic field. The oscillating magnetic field may be a pulsed magnetic field at a fixed frequency.

In one or more embodiments, the cavity enhancement module may include a first mirror and a second mirror at opposite sides of the holder.

In one or more embodiments, the method may further include sampling, by a first detector, an intensity of light polarized along a first polarization axis transmitted through the sample; and sampling, by a second detector, an intensity of light polarized along a second polarization axis transmitted through the sample.

In one or more embodiments, the determining the change in transmittance may further include determining a ratio of the intensity sampled by the first detector to the intensity sampled by the second detector.

In one or more embodiments, the method may further include normalizing the transmittance to 100% utilizing the ratio when the oscillating magnetic field is in the first state.

In one or more embodiments, the change in transmittance may be based on a change in the ratio between the first state of the oscillating magnetic field and the second state of the oscillating magnetic field.

In one or more embodiments, the method may further include determining a concentration of a paramagnetic material based on the change in transmittance.

According to one or more embodiments of the present disclosure, there is provided a method of extracting and detecting paramagnetic material in an aqueous medium, the method including: while applying a magnetic field to a column containing a metal mesh: loading a sample mixture into the column; and washing the column with a washing buffer; removing the magnetic field applied to the column; eluting a sample out of the column using an elution buffer; loading the sample into a holder in a cavity enhancement module; directing light from a light source to the sample in the holder; applying an oscillating magnetic field to the sample in the holder; determining a first level of transmittance with the oscillating magnetic field in a first state; changing a state of the oscillating magnetic field from the first state to a second state; determining a second level of transmittance with the oscillating magnetic field in the second state; and determining a change in transmittance of the light from the sample based on the first level of transmittance and the second level of transmittance.

In one or more embodiments, the washing the column may further include washing the column with a paramagnetic blocking agent.

According to one or more embodiments of the present disclosure, there is provided a system to detect paramagnetic material in an aqueous medium, the system including a holder in a cavity enhancement module, the holder being configured to receive a sample; a light source to emit light toward the sample in the holder; a magnet to apply an oscillating magnetic field to the sample in the holder, the oscillating magnetic field having a first state and a second state; and a processing circuit to determine a change in transmittance based on light from the sample.

In one or more embodiments, the magnet may include a first magnet and a second magnet configured to apply the oscillating magnetic field.

In one or more embodiments, the oscillating magnetic field may be a pulsed magnetic field at a fixed frequency.

In one or more embodiments, the cavity enhancement module may include a first mirror and a second mirror at opposite sides of the holder.

In one or more embodiments, system may further include: a first detector to sample an intensity of light polarized along a first polarization axis transmitted through the sample; and a second detector to sample an intensity of light polarized along a second polarization axis transmitted through the sample

In one or more embodiments, the processing circuit may be configured to determine a ratio of the intensity sampled by the first detector to the intensity sampled by the second detector.

In one or more embodiments, the processing circuit may be configured to normalize the transmittance to 100% utilizing the ratio when the oscillating magnetic field is in the first state.

In one or more embodiments, the change in transmittance may be based on a change in the ratio between the first state of the oscillating magnetic field and the second state of the oscillating magnetic field.

In one or more embodiments, the processing circuit may be configured to determine a concentration of a paramagnetic material based on the change in transmittance.

In one or more embodiments, the system may include: a column containing a metal mesh, the column being configured to receive a sample mixture; and a column magnet to selectively apply a magnetic field to the column, the column magnet being adjacent to the column

### BRIEF DESCRIPTION OF THE DRAWINGS

The above and other aspects and features of the present disclosure will be more clearly understood from the following detailed description of the illustrative, non-limiting example embodiments with reference to the accompanying drawings.

FIG. 1 is a block diagram illustrating a system for preparing and testing a sample according to one or more embodiments of the present disclosure.

FIG. 2 is an exploded view of a sample preparation device according to one or more embodiments of the present disclosure.

FIG. 3A is a block diagram illustrating a sample preparation device according to one or more embodiments of the present disclosure.

FIG. 3B is a flow chart illustrating a method of preparing a sample according to one or more embodiments of the present disclosure.

FIG. 4A is a block diagram illustrating a testing device according to one or more embodiments of the present disclosure.

FIG. 4B is a block diagram illustrating a source module according to one or more embodiments of the present disclosure.

FIG. 4C is a block diagram illustrating a sample module according to one or more embodiments of the present disclosure.

FIG. 4D is a block diagram illustrating a detection module and a data acquisition module according to one or more embodiments of the present disclosure.

FIG. 5A is a block diagram illustrating various systems communicating with each other to implement one or more embodiments of the present disclosure

FIG. 5B is a user interface according to one or more embodiments of the present disclosure.

FIG. 6 is a flow chart illustrating a method of testing a sample according to one or more embodiments of the present disclosure.

FIG. 7A is a graph illustrating an oscillating magnetic field applied by a magnet over time according to one or more embodiments of the present disclosure.

FIG. 7B is a graph illustrating transmittance over time according to one or more embodiments of the present disclosure.

FIG. 8 is a graph illustrating a standard curve for a paramagnetic material in an aqueous medium according to one or more embodiments of the present disclosure.

FIG. 9 is a graph illustrating change in transmittance converted to parasitemia levels according to one or more embodiments of the present disclosure.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, description thereof may not be repeated.

When malaria parasites are in the intraerythrocytic stage of their life cycle, the malaria parasites consume the hemoglobin of the host's red blood cells using a process that releases free heme. However, free heme is toxic to the malaria parasites and living cells generally. To protect against the toxicity of free heme, the malaria parasites convert the heme into an insoluble microcrystalline form of heme called hemozoin. This hemozoin has particular magnetic and optical properties (e.g., magnetic anisotropy, due to the presence of multiple Fe atoms, and optical (circular) dichroism) which may be exploited in accordance with one or more embodiments of the present disclosure to determine a concentration of hemozoin in a sample. Because hemozoin is a disposal product formed from the digestion of blood by certain blood-feeding parasites such as malaria parasites, a system and method according to one or more embodiments of the present disclosure may detect the presence and levels of malaria parasites based on the concentration of hemozoin in the sample, for example, to aid in clinical diagnosis, patient monitoring, and/or analysis of a treatment's efficacy.

Although the extraction and detection of hemozoin in whole blood is described to determine the presence of malaria parasites, this is a non-limiting example. The system and method described herein may be applied generally to any suitable paramagnetic material (e.g., paramagnetic crystal such as hemozoin) in any suitable complex aqueous medium (e.g., whole blood). Further, the presence of hemozoin may be indicative of other potential diagnoses (e.g., blood-feeding parasites other than malaria parasites) as determined by a clinician, and therefore, the system and method described herein are not limited to detection of malaria parasites.

For example, the systems and methods described herein may be applied in any setting or application where it may be desirable to, for example, extract and/or purify paramagnetic and/or optically anisotropic materials from a solution and/or measure the concentration of such materials. Accordingly, the systems and methods described herein may be incorporated, in whole or in part, chemical or biochemical process or processing device used for fabrication, purification, testing, quality control, research and development, etc., on any suitable scale (e.g., laboratory, industrial, etc.) with suitable changes to the systems and methods herein without departing from the spirit and scope of the present disclosure.

In more detail, the system and method according to one or more embodiments of the present includes preparing a sample for detection of paramagnetic materials from an aqueous medium using a magnetic field applied to a column including a metal mesh. The aqueous medium may be loaded into the column and certain buffers and a paramagnetic blocking agent may be applied to the column to separate the paramagnetic materials from the aqueous medium according to embodiments of the present disclosure. This process may result in high retention efficiency and high elution efficiency. In the case of extracting hemozoin from whole blood, the system and method resulted in a retention efficiency greater than 95% and an elution efficiency greater than 90%.

The system and methods described herein may exploit the optical properties of various paramagnetic materials to determine (e.g., quantify) a change in relative transmittance in a sample (e.g., a sample prepared according to one or more embodiments of the present disclosure). The relative change in transmittance may be used to determine a concentration of an optically anisotropic paramagnetic material in the sample prepared from the aqueous medium being analyzed.

In one or more embodiments, polarized light at a suitable wavelength may be transmitted through the sample placed in a cavity that includes a cavity enhancement module. The intensity of the polarized light transmitted through the sample may be sampled while an oscillating magnetic field (e.g., a pulsed magnetic field) is applied by one or more magnets. Based on the change in transmittance between when the magnetic field is applied and not applied, a concentration of the optically anisotropic paramagnetic material in the sample may be determined. The system and method according to one or more embodiments of the present disclosure was found to result in high sensitivity.

In the case of malaria, one particular embodiment of the system and method detected as few as 10-40 malaria parasites per microliter (μL) of blood, which is below the threshold parasitemia (e.g., 50 malaria parasites per microliter of blood) frequently observed in asymptomatic or pre-symptomatic individuals. Accordingly, one or more embodiments of the present disclosure may detect the presence of malaria parasites in hosts at an early stage or in asymptomatic hosts.

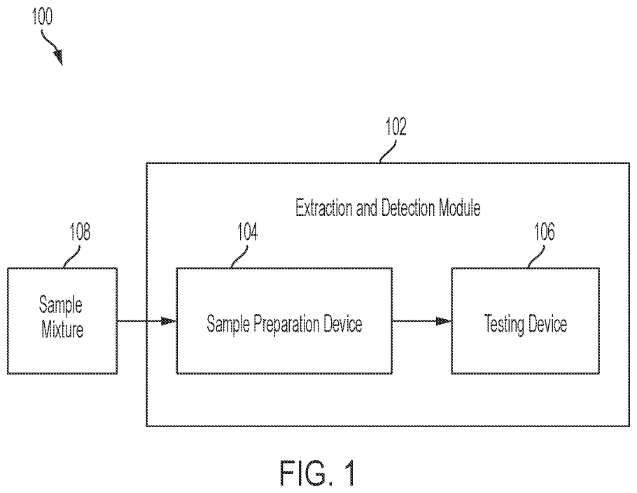

FIG. 1 is a block diagram illustrating a system 100 for preparing and testing a sample according to one or more embodiments of the present disclosure.

With reference to FIG. 1, an extraction and detection module 102 according to one or more embodiments of the present disclosure includes a sample preparation device 104 and a testing device 106. The sample preparation device 104 may receive a sample mixture (e.g., an aqueous medium that may contain a paramagnetic material) 108 and extract the paramagnetic material from the aqueous medium. The sample eluted from the sample preparation device 104 may be an optically clear solution that is loaded into the testing device 106. The testing device 106 may analyze the sample to determine a concentration of the paramagnetic material based on a relative change in transmittance.

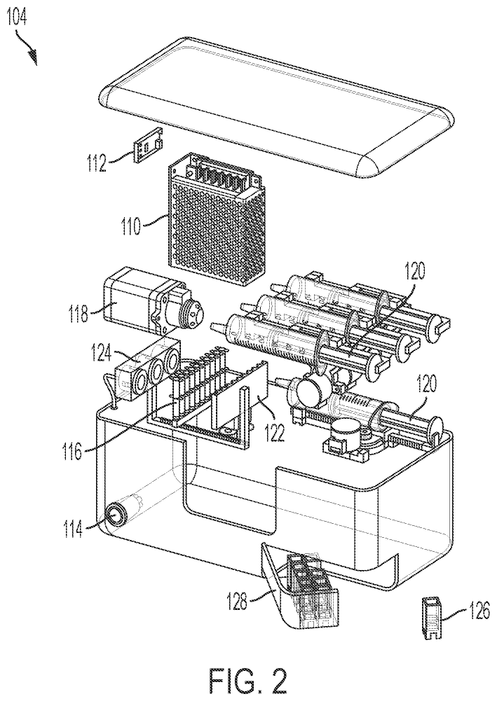

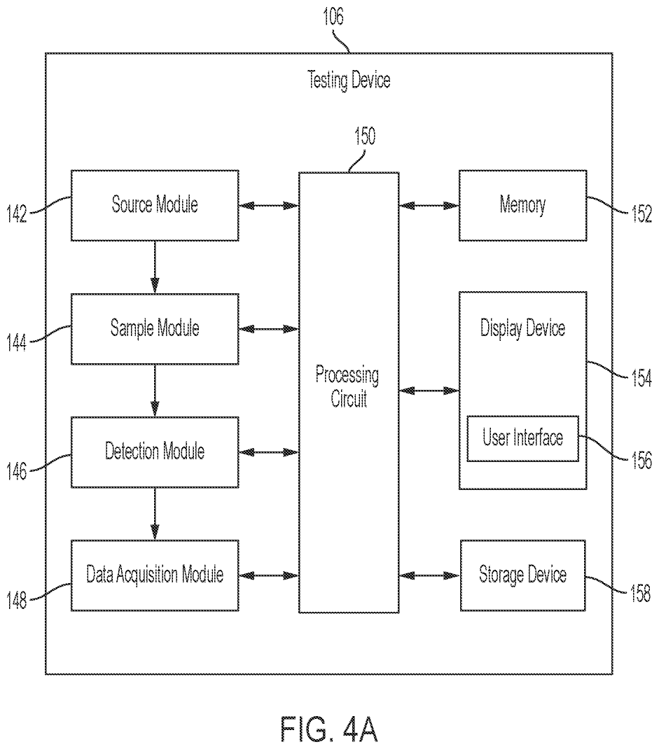

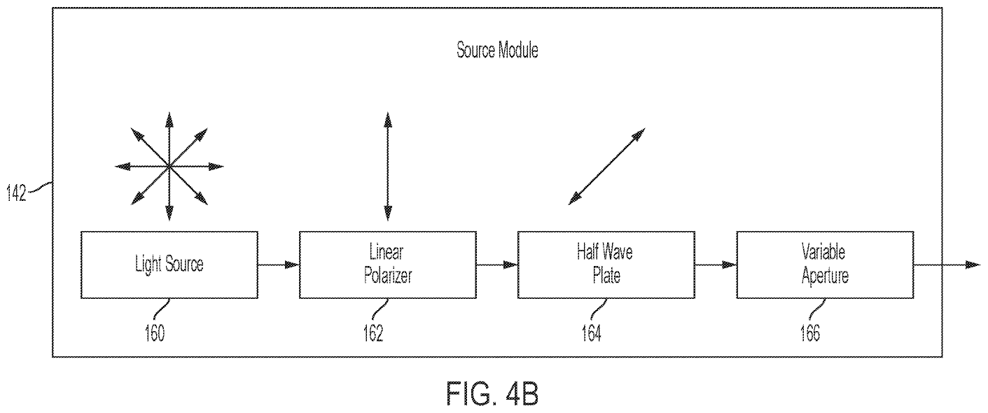

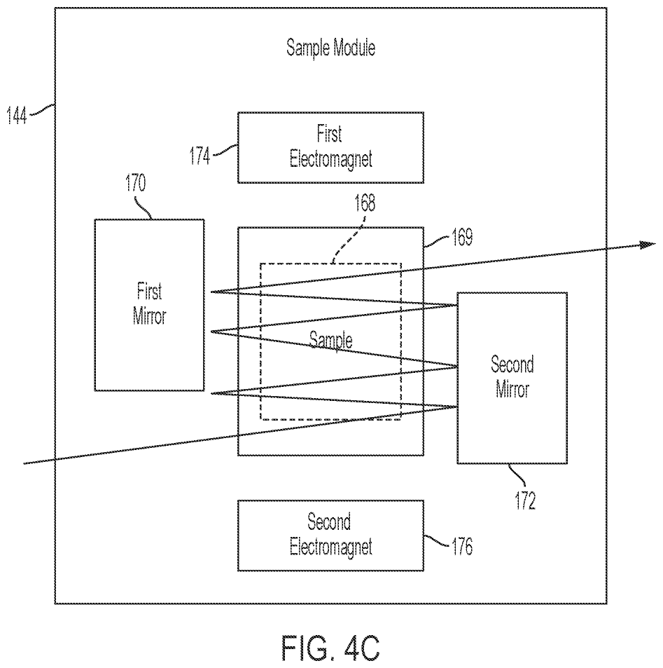

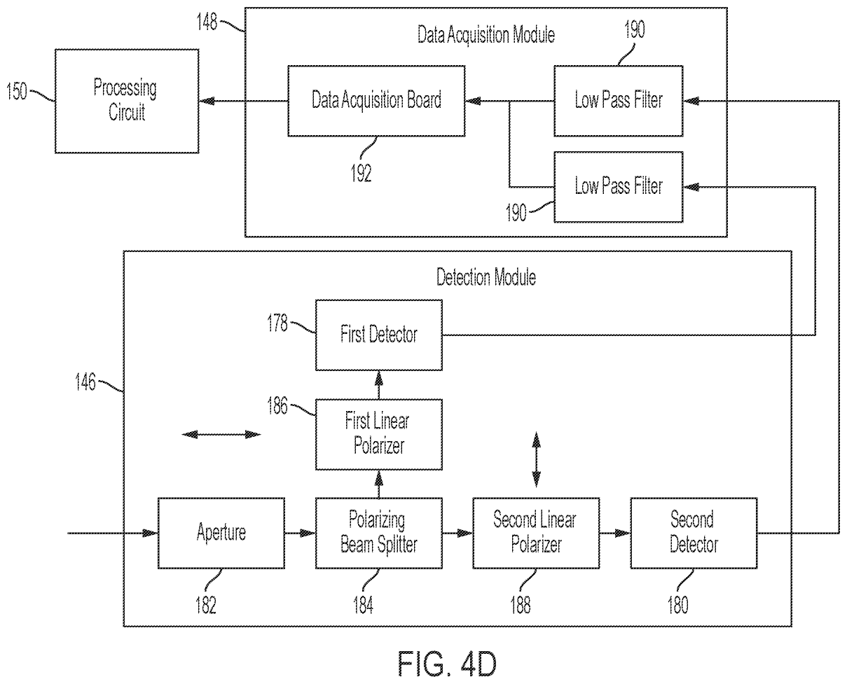

In one or more embodiments, the testing device 106 and the sample preparation device 104 may be a single automated or semi-automated system with the output of the sample preparation device 104 feeding directly into the input of the testing device 106. However, the present disclosure is not limited thereto. For example, as shown in FIGS. 2 and 4A, the sample preparation device 104 and the testing device 106 may be separate devices where the sample preparation device 104 does not feed directly into the testing device 106.

FIG. 2 is an exploded view of a sample preparation device according to one or more embodiments of the present disclosure.

With reference to FIG. 2, a sample preparation device 104 according to one or more embodiments of the present disclosure includes a power supply 110 and a controller 112 connected to the power supply 110. The controller 112 may include a processing circuit connected to various components of the sample preparation device 104 to control mechanical, electrical, and/or electromechanical components of the sample preparation device 104 to carry out one or more processes described herein. For example, the controller (e.g., the processing circuit of the controller) 112 may control one or more pumps, valves, transducers, robots, motors, and/or the like.

As used herein, the term “processing circuit” refers to any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, 1 each function is performed either by hardware configured (i.e., hard-wired, to perform that function) or by more general purpose hardware, such as a CPU, configured to execute instructions stored in a non-transitory storage medium (e.g., the memory connected to the processing circuit). The processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As shown in FIG. 2, the sample preparation device 104 may be powered on and off using a start button 114. The start button 114 may change the controller 112 from an off state, a sleep state, a hibernate state, or the like to a wake-up state.

Upon wake-up, the controller (e.g., the processing circuit of the controller) 112 may perform a system check to verify the condition of various components of the sample preparation device 104 and notify a user or another device of any issues that should be addressed such as, for example, low buffer levels, no available sample collectors (e.g., optical cuvettes), preventative maintenance, calibration issues, and/or the like.

In operation, the controller 112 may prepare one or more columns (e.g., purification columns) 116 including a metal mesh to be primed. In one or more embodiments, the metal mesh may be 100 milligrams (mg) to 120 mg of 434 fine grade stainless steel wool packed at about 0.6-0.8 mg/μL in a 150 μL volume column (e.g., a minivette column). However, the present disclosure is not limited thereto. In various embodiments, a suitable grade, material, amount of material, and density may be used depending on the paramagnetic material and aqueous medium with corresponding changes in retention and/or efficiency.

The controller 112 may connect the inlet of the one or more columns 116 to a port of a valve (e.g., a selector valve) 118 to control fluid delivery to the one or more columns 116. For example, the controller may use the valve 118 to connect a column 116 from among one or more columns 116 and a syringe 120 from among one or more syringes (e.g., one or more buffer syringes and/or air syringes) 120 to inject the contents of a selected syringe 120 into the selected column 116. As shown in FIG. 2, three syringes 120 containing a priming buffer, a washing buffer, and an elution buffer, respectively, are positioned above a syringe 120 containing air. However, the present disclosure is not limited to these syringes and the contents of the syringes may be changed in a suitable manner within the spirit and scope of the present disclosure. Further, although a syringe 120 is shown in FIG. 2, the present disclosure is not limited thereto. For example, any suitable type of pump (e.g., a peristaltic pump) may be used to deliver buffer and/or air to the one or more columns 116.

In one or more embodiments, the controller 112 may also control the application of a magnetic field to the one or more columns 116 by one or more magnets (e.g., one or more ferromagnets, electromagnets, or a combination thereof) 122. For example, the controller 112 may control positioning of a ferromagnet relative to the one or more columns and/or control positioning and application of a current to an electromagnet. As shown in FIG. 2, the controller 112 may be connected to an electric motor that is driven to change the position of the one or more columns 116 relative to a magnet (e.g., a ferromagnet or permanent magnet) 122 to move the one or more columns 116 into and outside of the magnetic field applied by the magnet 122.

In one or more embodiments, the electric motor may be driven to change the position of the one or more column 116 relative to a transducer (e.g., an ultrasonic transducer) 124 which may be used to agitate the contents of the column 116 (e.g., agitate the contents of the column by transmitting sound waves into contacting the column, either via direct contact or via a transducing medium). However, the present disclosure is not limited thereto any suitable agitation mechanism may be used.

At the conclusion of sample preparation, the controller 112 may enable one or more sample collectors 126 to be in fluid communication with one or more columns 116 to elute a sample from the one or more columns 116 into a sample collector 126 from among the sample collectors 126 in a drawer 128. The sample collector 126 may be transferred to a testing device 106 for subsequent testing. However, the present disclosure is not limited thereto. For example, instead of separately transferring the sample collector 126 to a testing device 106 (e.g., by manually removing the sample collector 126 from the drawer 128), the sample may be loaded directly into a sample collector 126 in the testing device 106.

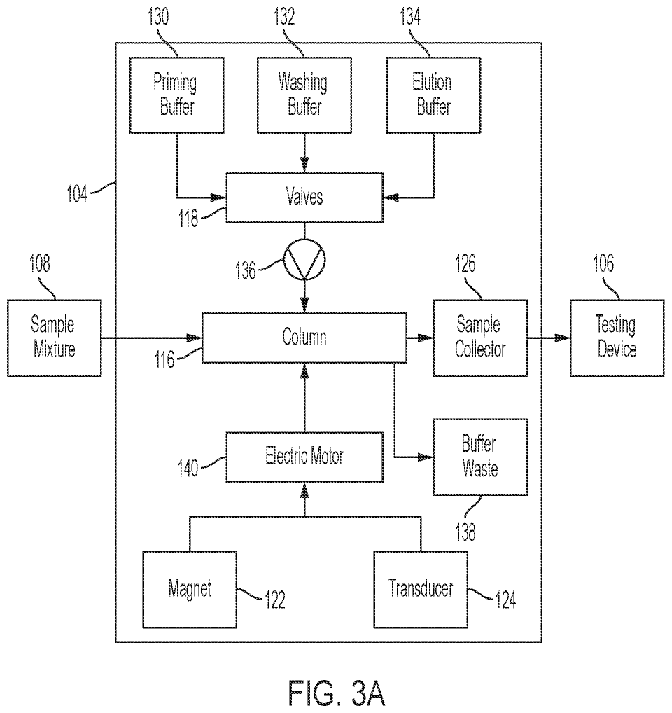

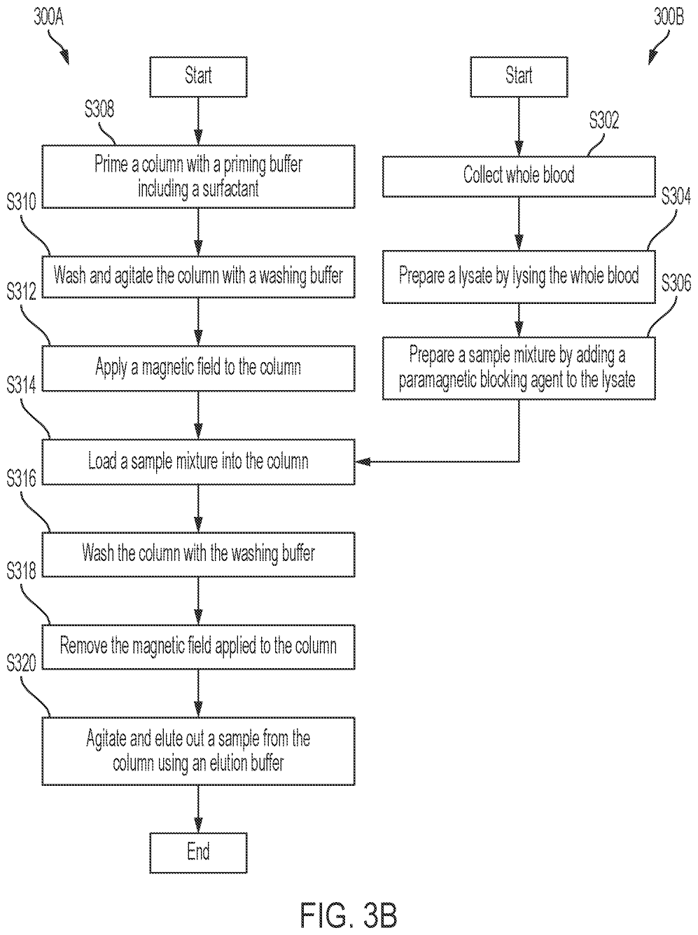

FIG. 3A is a block diagram illustrating a sample preparation device 104 according to one or more embodiments of the present disclosure. FIG. 3B is a flow chart illustrating a method of preparing a sample according to one or more embodiments of the present disclosure.

With reference to FIG. 3A, a sample preparation device 104 according to one or more embodiments of the present disclosure may include a column 116 including a metal mesh to receive a sample mixture 108. Depending on the sample mixture 108, additional processing may be performed prior to loading the sample mixture 108 into the column 116. For example, in the case of whole blood, the whole blood may first be collected, lysed, and treated with a paramagnetic blocking agent.

In more detail, as shown in FIG. 3B, whole blood may first be collected (S300) from a person for analysis, for example, by using a finger prick to provide up to about 400 μL of whole blood for analysis. However, the present disclosure is not limited thereto. For example, any suitable method for collecting or drawing blood from a person may be used.

A total volume of whole blood to be collected for analysis by the sample preparation device 104 according to one or more embodiments of the present disclosure may be between 290 μL to 310 μL. However, the present disclosure is not limited thereto. For example, a larger volume of whole blood may be collected to improve a limit of detection (LOD) of malaria parasites (e.g., enable detection of lower malaria parasite loads).

After collection of the whole blood, a lysate may be prepared by lysing the whole blood (S304), for example by diluting the blood sample in a lysis buffer. However, the present disclosure is not limited thereto. For example, any lysis reagent may be used as long as the sensitivity of the paramagnetic material of interest (e.g., hemozoin) is not changed or not substantially changed. In one or more embodiments, any suitable osmolysis reagents including, but not limited to, de-ionized water may be used. The lysis buffer may be any suitable buffer having a pH between 7.4 to 8.8, 0.03 to 0.07% (w/v) and a volume of 2.6 milliliters (mL) to 2.8 mL. However, the present disclosure is not limited thereto. In one or more embodiments, the lysis buffer to dilution factor is 10× (one parts lysis reagents and nine parts whole blood sample). However, the present disclosure is not limited thereto.

Generally, lysing the whole blood to prepare the sample mixture 108 may be sufficient minimal preparation for loading in the column 116 of FIGS. 2 and 3A in order to extract hemozoin. However, subsequent experimentation yielded the insight that whole blood generally includes small light-absorbing paramagnetic species such as deoxygenated hemoglobin in addition to hemozoin. These small light-absorbing paramagnetic species may not cause an undesirable relative change in transmittance in response to a change in magnetic field; however, the small light-absorbing paramagnetic species may uniformly reduce transmittance which may limit sensitivity and specificity of detection of hemozoin.

As such, to mitigate potential noise from background Fe-containing groups (e.g., small light-absorbing paramagnetic species) of the whole blood, the method of preparing the sample mixture 108 according to one or more embodiments of the present disclosure further includes adding a paramagnetic blocking agent (e.g., adding strongly paramagnetic gadolinium (III) ions) to the lysate (S306). The paramagnetic blocking agent (e.g., gadolinium (III) ions having seven unpaired electrons) may outcompete most weakly paramagnetic light-absorbing species (e.g., deoxygenated hemoglobin having four unpaired electrons) in the whole blood for binding to the metal mesh of the column 116 of the sample preparation device 104 as the sample mixture 108 is passed through the column 116. Accordingly, most of the weakly paramagnetic light-absorbing species in whole blood may not bind to the metal mesh of the column 116, and, as will be described in more detail below, the weakly paramagnetic light-absorbing species may be washed out (e.g., eluted separately from the paramagnetic species of interest).

In one or more embodiments, gadolinium (III) ions and/or any other suitable strongly paramagnetic blocking agent ion may be added to the lysate to a Gd³⁺ concentration of 20 micromolar (μM) is reached. However, the present disclosure is not limited thereto and any suitable concentration (e.g., a Gd³⁺ concentration between 20 μM to 40 μM) may be used.

As shown in FIG. 3A, the sample preparation device 104 may include one or more containers for holding a priming buffer 130, a washing buffer 132, and an elution buffer 134. The one or more containers holding the priming buffer 130, the washing buffer 132, and the elution buffer 134 may be connected to a column 116 by valves (e.g., solenoid valves) 118.

In one or more embodiments, the priming buffer 130 may include 1× Tris buffer saline (TBS) and sodium dodecyl sulfate (SDS) at an SDS concentration of 0.9 to 1.1% (w/v). However, the present disclosure is not limited thereto. For example, the priming buffer 130 may include any suitable buffer solution having a pH of 7.4 to 8.8 and any suitable surfactant such as SDS, Triton X-100, Tween 20, and/or the like at any suitable concentration.

In one or more embodiments, the washing buffer 132 may include 1×TBS. However, the present disclosure is not limited thereto. For example, the washing buffer 132 may include any suitable buffer solution having a pH of 7.4 to 8.8. Further, in one or more embodiments, a paramagnetic blocking agent may further be included in the washing buffer 132 either in a same container or a separate container for mixing prior to being loaded into the column 116. In this case, the paramagnetic blocking agent may include gadolinium (III) ions which may be added to the washing buffer 132 to a Gd³⁺ concentration of 20 μM is reached. However, the present disclosure is not limited thereto and any suitable strongly paramagnetic ions may be used at any suitable concentration (e.g., a Gd³⁺ concentration between 20 μM to 40 μM).

In one or more embodiments, the elution buffer 134 may include 10×TBS. However, the present disclosure is not limited thereto. For example, the elution buffer 134 may include any suitable buffer solution having a pH of 7.4 to 8.8.

As shown in FIGS. 3A and 3B, the method of preparing the sample may include priming the column 116 with the priming buffer 130 including a surfactant (S308) from the container via any suitable valve (e.g., a solenoid valve from among the valves) 118 using any suitable pump 136 such as a peristaltic pump. The priming buffer 130 may wet or coat the metal mesh of the column 116 evenly and wash away any hydrophobic residues. In one or more embodiments, the column 116 may be primed with 250 μL to 350 μL of the priming buffer 130 and, in a non-limiting example, priming may occur while the sample mixture 108 is being prepared (e.g., while the whole blood is being lysed in accordance with acts S302, S304, and/or S306 as shown in FIG. 3B). Although specific volumes and timing is described, the present disclosure is not limited thereto.

After priming the column 116 (S308), the method of preparing the sample may include washing and agitating the column 116 with the washing buffer 132 (S310) from the container. Fluid delivery may again be provided via the valves 118 using any suitable pump 136 and agitation may be performed using a transducer (e.g., an ultrasonic transducer) 124 as shown in FIG. 3A. However, the present disclosure is not limited thereto. For example, any suitable mechanism may be used to agitate the column 116 in combination with or separate from the transducer 124.

The washing and agitating may further remove any remaining residues. In one or more embodiments, this act of washing and agitating (S310) may be repeated up to three times using 280 μL to 320 μL of washing buffer 132 each time. However, the present disclosure is not limited thereto and any suitable number of the washing and agitating act (S310) may be performed and any suitable volume may be used.

Waste from the washing and agitating act (S310) may be collected in a container for buffer waste 138 as shown in FIG. 3A. The buffer waste 138 may be further analyzed or disposed of as desired.

After priming and washing (S308 and S310), the metal mesh of the column 116 may be ready for binding to a target paramagnetic material. In one or more embodiments, a processing circuit may control an electric motor 140 to move the column 116 toward a magnet 122 and away from the transducer 124 thereby exposing the column 116 to a magnetic field. Accordingly, the method may include applying a magnetic field to the column 116 (S312). In one or more embodiments, a magnetic field of 0.5 Tesla may be applied by two neodymium magnets. However, the present disclosure is not limited thereto. For example, in the case of separating hemozoin from a sample mixture 108 described above, in one or more embodiments, a magnetic field having strength of 0.4 Tesla or higher was found to be sufficient. However, various factors (e.g., different metal mesh structures, different paramagnetic materials, and the presence of other paramagnetic species) may result in different ranges of appropriate magnetic field strength for retaining (and subsequently eluting) the paramagnetic species of interest.

While the magnetic field is applied to the column 116, the sample mixture 108 may be loaded into the column (e.g., using a pipette, syringe, or any other suitable loading device) 116 (S314). In the case of whole blood, the sample mixture 108 may be loaded after lysis (e.g., osmolysis) is complete (e.g., see S304) and, in one or more embodiments, after a paramagnetic blocking agent is added to the lysate (S306).

The whole blood in the column 116 may be extracted using gravity. However, the present disclosure is not limited thereto and any suitable extraction mechanism may be used (e.g., by applying a pressurized gas to the column 116).

While the column 116 remains exposed to the magnetic field, the column 116 may be washed again with washing buffer 132 (S316) to remove any undesired waste products. In the case of extracting hemozoin from whole blood, undesired waste product may include light scattering proteins and cell debris. Further, in one or more embodiments, the washing buffer 132 may also include a paramagnetic blocking agent (e.g., gadolinium (III) ions added to the washing buffer 132 to a Gd³⁺ concentration of 20 μM to 40 μM is reached). This washing act (S316) including washing buffer 132 with or without the paramagnetic blocking agent may be repeated three times using 290 μL to 310 μL of washing buffer 132 each time relative to a 150 μL volume packed column (e.g., a minivette column at 0.6-0.8 mg/μL of stain-less steel wool). However, the present disclosure is not limited thereto and any suitable number of the washing acts (S316) may be performed and any suitable volume of washing buffer may be used depending, for example, on the volume of the column. As shown in FIG. 3A, delivery of the washing buffer 132 may again be provided via the valves 118 using any suitable pump 136.

After washing (S316), the magnetic field applied to the column 116 may be removed (S318). For example, the processing circuit may control the electric motor 140 to move the column 116 toward the transducer (e.g., until the column 116 is in contact with the transducer) 124 and away from the magnet 122 thereby removing the magnetic field applied to the column 116 (e.g., by removing the column 116 from the magnetic field). Although removal from the magnetic field via movement of the column 116 is described, the present disclosure is not limited thereto. For example, in the case of an electromagnet, the processing circuit may turn off a current supplied to the electromagnet. Further, as used herein, “removing the magnetic field applied to the column” may refer to reducing the magnetic field applied to the column to a value below 10% of the stimulation strength in, for example, the case of moving the permanent magnets away from the column.

In one or more embodiments, the method of preparing the sample may include agitating and eluting out a sample from the column 116 using an elution buffer 134 (S320). The elution buffer 134 may be 10×TBS and may not contain the paramagnetic blocking agent (e.g., gadolinium (III) ions).

For example, the elution buffer 134 may be added to the column 116 via the valves 118 using any suitable pump 136, and the contents of the column 116 may be agitated using the transducer 124 to help un-bind paramagnetic materials. The elution buffer 134 traveling or pumped through the column 116 may be deposited into a sample collector 126 as shown in FIG. 3A. In one or more embodiments, a volume of the elution buffer 134 to be used may be 299 μL to 301 μL relative to a 150 μL volume packed column (e.g., a minivette column at 0.6-0.8 mg/μL of stain-less steel wool). However, the present disclosure is not limited thereto and any suitable volume of elution buffer 134 may be used.

Generally, the resultant solution (or sample) may be optically clear, and, in the case where the paramagnetic material is hemozoin and the aqueous medium is whole blood, the sample contains concentrated hemozoin extracted from lysed cells and free hemozoin.

The method and processes described with respect to FIG. 3B may be performed manually, by an automated process, and/or by a semi-automated process. For example, the above-described process may be performed manually at a laboratory bench, by a sample preparation device 104 as show in FIGS. 2 and 3A, a liquid chromatography device, a robot (e.g., a humanoid or other robot), an industrial flow or batch-based chemical process, or any combination thereof. Further, the above-described method may be applied to extract any suitable paramagnetic material from any suitable aqueous medium.

In addition, the method and processes described with respect to FIG. 3B, in one or more embodiments, may generally be performed at room temperature. However, the present disclosure is not limited thereto. For example, an operating temperature range of 10 degrees Celsius (° C.) to 45° C. may be provided for the sample preparation device 104 in accordance with one or more embodiments of the present disclosure. Further, a method (or process) 300A including acts S308, S310, S312, S314, S316, S318, and S320 may be may be applied for preparing a sample by extracting a paramagnetic material of interest from a sample mixture generally while a method (or process) 300B including acts S302, S304, and S306 provide a non-limiting example in the case of preparing a sample from whole blood. Accordingly, the method (or process) 300A may be used without the method (or process) of 300B depending on the paramagnetic material of interest and the aqueous medium from which the paramagnetic material is to be extracted.

FIG. 4A is a block diagram illustrating a testing device 106 according to one or more embodiments of the present disclosure. FIG. 4B is a block diagram illustrating a source module 142 according to one or more embodiments of the present disclosure. FIG. 4C is a block diagram illustrating a sample module 144 according to one or more embodiments of the present disclosure. FIG. 4D is a block diagram illustrating a detection module 146 and a data acquisition module 148 according to one or more embodiments of the present disclosure.

Referring to FIG. 4A, a testing device 106 according to one or more embodiments of the present disclosure includes a processing circuit 150 connected to one or more of a source module 142, a sample module 144, a detection module 146, and a data acquisition module 148. The processing circuit 150 may execute instructions stored in memory 152 to carry out some or all of the operations described herein such as determining ratios of an intensity of light, transmittance, change in transmittance, concentrations of optically anisotropic paramagnetic materials, and/or the like. Further, the processing circuit 150 may control operation of components of the source module 142, the sample module 144, the detection module 146, and/or the data acquisition module 148 to carry out the processes described herein.

In one or more embodiments, the processing circuit 150 may be connected to a display device 154 providing a user interface 156 for interaction with a user. For example, the processing circuit 150 may request (or display) and receive, via the user interface 156, input including, but not limited to, patient identification information, calibration information, a measurement request, and/or a save request. The processing circuit 150 may also organize and output results and/or metadata as desired by the user. In one or more embodiments, the processing circuit 150 may be connected to a storage device 158 to store desired information, data, and/or metadata (e.g., metadata relating to operation of the testing device 106 such as calibration information, information relating to conditions during data collection, and the like).

Referring to FIG. 4B, a source module 142 according to one or more embodiments of the present disclosure includes a light source (e.g., a light source emitting coherent light such as a laser) 160. The light source 160 may emit light in the infrared or near infrared wavelength range with suitable changes depending on, for example, an absorption peak of the paramagnetic material to be detected. In one or more embodiments, the wavelength of the light source 160 may be selected based on selecting a wavelength that is not strongly absorbed by the aqueous medium containing the paramagnetic material of interest. In the case of hemozoin, a 670 nm wavelength was determined to have the highest level of magneto-optic interaction over a wavelength range of 300 nm to 1300 nm. However, the present disclosure is not limited thereto. For example, in the case of hemozoin, the wavelength emitted by the light source 160 may be between 660 nm to 678 nm.

The source module 142 may further include optical components such as a linear polarizer 162, a half wave plate 164, and a variable aperture 166. The linear polarizer 162 may be between the light source 160 and the half wave plate 164, and the half wave plate 164 may be between the linear polarizer 162 and the variable aperture 166. Accordingly, light emitted by the light source 160 may be transmitted through the linear polarizer 162 to the half wave plate 164 to the variable aperture 166.

In operation, as shown in FIG. 4B, light emitted from the light source 160 may be linearly polarized by the linear polarizer 162 and then transmitted to the half wave plate 164. The half wave plate 164 may reorient or rotate the polarization of light transmitted through the half wave plate 164 before the polarized light is transmitted through the variable aperture 166. The variable aperture 166 may shape the polarized light (e.g., a beam of polarized light) into a smaller profile and direct the polarized light toward a sample of the sample module 144. In one or more embodiments, the variable aperture 166 may have diameter between 0.6 millimeters (mm) to 1.0 mm. However, the present disclosure is not limited thereto. Accordingly, the source module 142 may provide a “clean” source of polarized light at a desired wavelength for the sample module 144.

Referring to FIG. 4C, a sample module 144 according to one or more embodiments of the present disclosure includes a sample 168 in a holder 169 placed in a cavity enhancement module. The cavity enhancement module may include optical components suitable for extending confinement (e.g., extending a path length) of light within a cavity. For example, the cavity enhancement module may include a first mirror 170 and a second mirror 172 with the holder 169 including the sample 168 therebetween. In other words, the first mirror 170 and the second mirror 172 may be at opposite sides of the holder 169. By providing the sample 168 in the cavity enhancement module, the polarized light, from the source module 142, reflects between the first and second mirror 172, thereby increasing the path length of the light within the cavity such that the light may have increased optical interactions with any paramagnetic materials in the sample 168. Accordingly, any optical and/or optical-magnetic effects caused by constituents (e.g., paramagnetic materials) of the sample 168 may be enhanced for increased signal quality during subsequent detection. Further, by providing the cavity enhancement module, light from the source module 142 may pass through the sample 168 multiple times as opposed to a single pass thereby enabling a reduced form factor for the sample module 144 for a given total path length. In one or more embodiments, a path including six or more reflections may be used to result in a path length greater than 110 mm. However, the present disclosure is not limited thereto and any suitable number of reflections or arrangements of components may be used to result in a path length of greater than 110 mm.

In one or more embodiments, the sample 168 and corresponding holder 169 may also be positioned between any suitable type or number of magnets capable of providing an oscillating magnetic field. For example, the first magnet and the second magnet may be a first electromagnet 174 and a second electromagnet 176, respectively. However, the present disclosure is not limited thereto. For example, one or more ferromagnets may be moved and/or rotated to remove and/or produce an oscillating magnetic field. In the case of a first electromagnet 174 and a second electromagnet, the first electromagnet 174 and the second electromagnet 176 may have an ON state (e.g., the oscillating magnetic field is in a second state) and an OFF state (e.g., the oscillating magnetic field is in a first state).

In an ON state, the first electromagnet 174 and the second electromagnet 176 may be “on” (e.g., a current may be applied to the electromagnet) and paramagnetic materials present in the sample 168 may be oriented based on the magnetic field generated by the first electromagnet 174 and the second electromagnet 176. Due to the orientation of the paramagnetic materials in the context of an optically anisotropic paramagnetic material (e.g., hemozoin), the transmittance of light through the sample 168 may increase along a polarization axis (e.g., a polarization axis perpendicular to the magnetic field) and decrease along another polarization axis (e.g., another polarization axis orthogonal to the polarization axis).

In an OFF state, the first electromagnet 174 and the second electromagnet 176 may be “off” (e.g., a current may not be applied to the electromagnet) and the paramagnetic materials present in the sample 168 may be arranged in random orientations. As such, transmittance of light through a sample 168 including paramagnetic materials in the context of an optically anisotropic paramagnetic material may not be expected to increase along the polarization axis and decrease along the other polarization axis in the same manner as when the first electromagnet 174 and the second electromagnet 176 are in the ON state. For example, because the paramagnetic materials are randomly oriented in the OFF state, an increase in transmittance along the polarization axis and a decrease in transmittance along the other polarization axis may not be observed in the OFF state.

Accordingly, as shown in FIG. 4C, polarized light may be transmitted through a cavity enhanced module containing the sample 168 while the first electromagnet 174 and the second electromagnet 176 are selectively toggled between the ON state and the OFF state.

In one or more embodiments, a current may be applied to the first electromagnet 174 and the second electromagnet 176 to produce an oscillating magnetic field (e.g., a pulsed magnetic field) at a fixed frequency (e.g., the magnetic field may be pulsed to flip opposite poles of the magnetic field at the fixed frequency). As the magnetic field oscillates, the paramagnetic materials may change orientation in accordance with the change in the magnetic field. In one or more embodiments, the magnetic field may oscillate (e.g., be pulsed on and off) with a field strength reaching about 0.33 T. However, the present disclosure is not limited thereto and any suitable field strength may be used.

For example, the first electromagnet 174 and the second electromagnet 176 may have a first configuration where the first electromagnet 174 may function as the north pole and the second electromagnet 176 may function as the south pole, and a second configuration where the first electromagnet 174 may function as the south pole and the second electromagnet 176 may function as the north pole. In this case, one or more detectors (e.g., a first detector 178 and a second detector 180 shown in FIG. 4D) may sample light when the first electromagnet 174 and the second electromagnet 176 are in the first configuration for a first period of time and sample light when the first electromagnet 174 and the second electromagnet 176 are in the second configuration for a second period of time. By sampling light while the first electromagnet 174 and the second electromagnet 176 flip or switch between the first configuration and the second configuration, a signal-to-noise ratio (SNR) may be increased.

Although applying an oscillating magnetic field may be used to enhance SNR, oscillating the magnetic field at some frequencies may not produce the desired effect. For example, if the oscillating magnetic field oscillates at too high of a frequency, then the paramagnetic materials may not have enough time to reorient and SNR may not be enhanced. To produce the desired enhancement in SNR, the magnetic field should be oscillated within a frequency range based on the size of the paramagnetic material to be detected and a viscosity of the sample 168. In the case of hemozoin and the sample 168 prepared according to one or more embodiments of the present disclosure, the fixed frequency may be a value less than or equal to 60 Hz.

Referring to FIG. 4D, a detection module 146 according to one or more embodiment of the present disclosure includes an aperture 182, a polarizing beam splitter 184, a first linear polarizer 186, a second linear polarizer 188, a first detector (e.g., a first photodetector) 178, and a second detector (e.g., a second photodetector) 180.

Light from the sample module 144 may be transmitted through the aperture 182 to filter out any undesirable light or reflections caused by the cavity enhancement module of the sample module 144. The remaining light may be transmitted to the polarizing beam splitter 184. The polarizing beam splitter 184 may split (or isolate) incident light into a first polarized light (e.g., a horizontally polarized light) and a second polarized light orthogonal to the first polarized light (e.g., a vertically polarized light) to be transmitted through the first linear polarizer 186 (e.g., with a horizontal polarization axis) and the second linear polarizer 188 (e.g., with a vertical polarization axis), respectively. The first linear polarizer 186 and the second linear polarizer 188 may “clean up” any issues due to reflectance/scattering with the light from the polarizing beam splitter 184 prior to detection by the first detector 178 and the second detector 180, respectively.

The first detector 178 may sample the first polarized light received from the first linear polarizer 186 and the second detector 180 may sample the second polarized light received from the second linear polarizer 188. By sampling both a first polarized light and a second polarized light having polarization axes orthogonal to each other, a greater sensitivity to changes in transmittance may be provided.

The first detector 178 and the second detector 180 may then transmit signals indicating the intensity of light detected to a data acquisition module 148.

As shown in FIG. 4D, the data acquisition module 148 includes a plurality of low pass filters 190 and a data acquisition board 192 connected to the plurality of low pass filters (e.g., low pass filters having as 1 kHz cutoff to reduce noise) 190. Signals transmitted by the first detector 178 and the second detector 180 may be processed by corresponding ones of the plurality of low pass filters 190 prior to being processed or sampled by the data acquisition board (e.g., a multi-channel data acquisition board) 192 for manipulation by a connected processing circuit 150. In one or more embodiments, the data acquisition board 192 may sample at 5 kHz to 10 kHz at 12 bits or higher. However, the present disclosure is not limited thereto.

In one or more embodiments, the processing circuit 150 may receive the signals from the data acquisition board 192 for further processing. For example, the processing circuit 150 may determine (e.g., continuously determine) a ratio of the intensity of light detected by the first detector 178 to the intensity of light detected by the second detector 180. The light may be detected by the first detector 178 and the second detector 180 during the first period of time and the second period of time (i.e., while the first electromagnet 174 and the second electromagnet 176 are selectively toggled or pulsed between the ON state and the OFF state).

The processing circuit 150 may then use the ratio determined when the first electromagnet 174 and the second electromagnet 176 are in the OFF state (i.e., when no external, applied magnetic field is present) as a transmittance baseline that is normalized to 100%, and may use the ratio determined when the first electromagnet 174 and the second electromagnet 176 are in the ON state (e.g., when an external magnetic field is applied) to calculate a change in level of transmittance, as associated with the change between OFF and ON states (e.g., the first and second states). As such, as used herein, “a change in transmittance” may refer to a change in ratio (e.g., light intensity ratio) because the amount of light transmitted through the cavity depends on the concentration of the optically anisotropic paramagnetic materials and the applied external magnetic field.

As one non-limiting example, change in transmittance may be calculated in accordance with Equation 1 below:

$$Δ T \% = \frac{100 \times ( {T}_{OFF} - {T}_{ON} )}{\frac{{T}_{OFF} + {T}_{ON}}{2}} = \frac{200 \times ( {T}_{OFF} - {T}_{ON} )}{( {T}_{OFF} + {T}_{ON} )}$$

where ΔT % is the relative change in transmittance (e.g., a change in a normalized ratio), T_{OFF} is the normalized ratio when the magnetic field is off, and T_{ON} is the normalized ratio when the magnetic field is on.

In one or more embodiments, the processing circuit 150 may convert the relative change in transmittance to a concentration based on a standard curve or any other suitable method. Further, in the case of hemozoin detection, the processing circuit 150 may convert a hemozoin concentration to a parasitemia level using any known conversion method such as techniques described in (1) “Evaluation of a novel magneto-optical method for the detection of malaria parasites” by Orban et al. (2014), the entire contents of which are incorporated herein by reference, and (2) “A magneto-optic route toward the in vivo diagnosis of malaria: Preliminary results and preclinical trial data” by Newman et al. (2008), the entire contents of which are incorporated herein by reference. The standard curve data for a paramagnetic material and known conversion methods (e.g., known methods for converting a concentration of hemozoin into a parasitemia level) may be stored in the storage device 158 of the testing device 106 or may be stored on an external device in communication with the processing circuit 150.

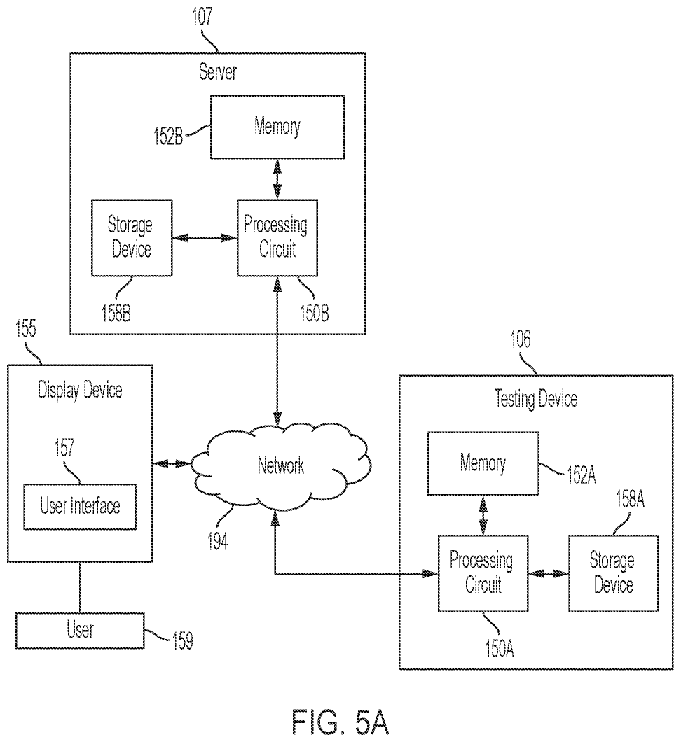

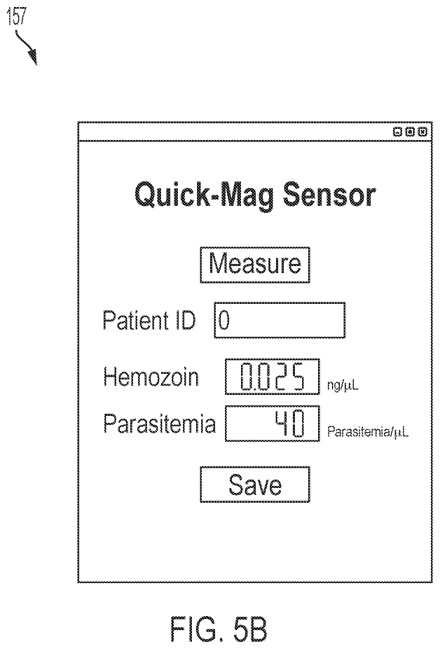

FIG. 5A is a block diagram illustrating various systems communicating with each other to implement one or more embodiments of the present disclosure.

With reference to FIG. 5A, various systems according to one or more embodiments of the present disclosure may include a testing device 106 as described with reference to FIGS. 4A-4D, a display device 155 such as, for example, a personal computer, a laptop, a mobile phone, a tablet, a game station, a television, or any other suitable display device including a touchpad, a touch screen, a voice-guided input device, a mouse, a keyboard, a microphone, and/or the like, and/or a server 107 including a storage device (e.g., a mass storage device) 158B such as, for example, a disk drive, drive array, flash memory, magnetic tape, or other suitable storage device.

The display device 155, the testing device 106, and/or the server 107 may be connected to each other via a network 194 using a telephone connection, a satellite connection, a cable connection, a radio frequency communication, or any suitable wired or wireless data communication mechanism. Accordingly, the server 107, the display device 155, and/or the testing device 106 may share patient information, results, standard curves, calibration data, testing device 106 metadata, and/or the like, which may be stored on a storage device 158B of the server 107, a storage device of the display device 155, and/or a storage device 158A of the testing device 106. Although a storage device is included in the server 107, the display device 155, and the testing device 106 as illustrated in FIG. 5A, the present disclosure is not limited thereto. For example, an internal storage device may be omitted and an external storage device may be used.

In one or more embodiments, a processing circuit 150B of the server 107, a processing circuit of the display device 155, and/or a processing circuit 150A of the testing device 106 may, alone or in combination, execute instructions in memory (e.g., volatile or non-volatile memory for storing data and/or computer code) to complete or facilitate the various processes described herein. For example, the processing circuits of the server 107, the display device 155, and/or the testing device 106 may, alone or in combination, control operation of components of the source module 142, the sample module 144, the detection module 146, and/or the data acquisition module 148 of a testing device 106 and/or determine transmittance, change in transmittance, concentrations of paramagnetic materials, and/or the like.

FIG. 5B is a user interface 157 according to one or more embodiments of the present disclosure.

With reference to FIG. 5B, a user 159 may use a user interface 157 (e.g., in a web browser or application) to perform various functions. As shown in FIG. 5A, the user interface 157 is depicted as provided by the display device 155. However, the present disclosure is not limited thereto. For example, the user interface 157 may be separately provided (e.g., duplicated) by one or more of the display device 155, the server 107, and the testing device 106. In one or more embodiments, the user interface 157 be the same as or similar to the user interface 156 described with reference to FIG. 4.

In any case, the processing circuit of the display device 155, the server 107, and/or the testing device 106 may execute instructions in corresponding memory to provide, via the user interface 157, a control dashboard including operational steps such as placing samples on the holder 169, entering a patient ID, and/or measuring/collecting data. The processing circuit may further display, via the user interface 157, data requested by the user 159 such as hemozoin concentration and parasitemia levels as shown in FIG. 5B. The user 159 may also have the option of remeasuring by pressing measure again or saving any data for reference at a subsequent time.

In one or more embodiments, the amount of time between pressing measure and receiving the data depicted in FIG. 5B was 8-10 seconds. As such, measurements may be performed fairly rapidly.

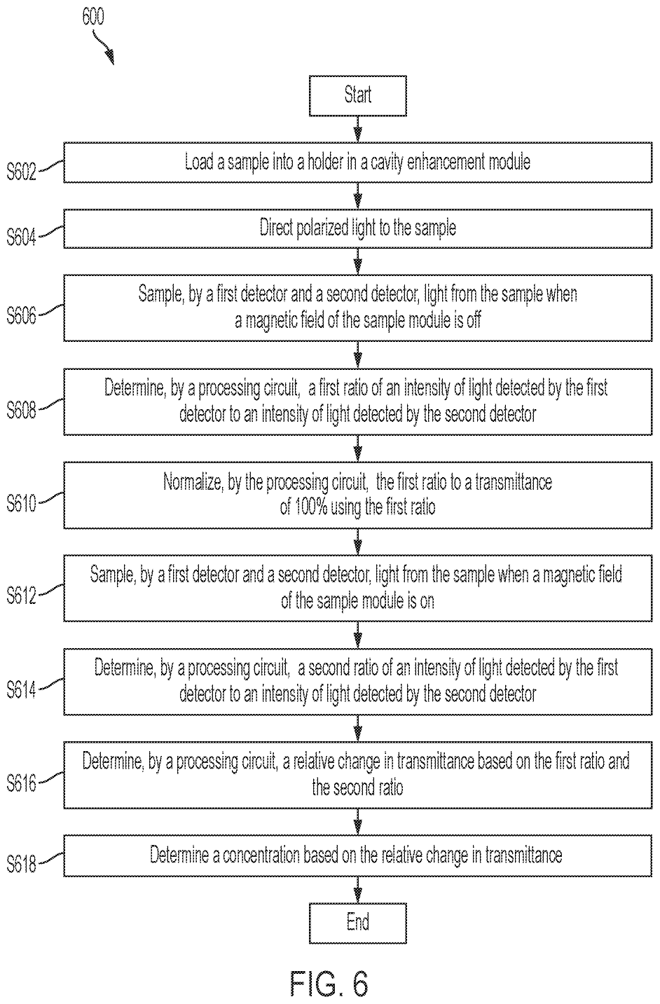

FIG. 6 is a flow chart illustrating a method of testing a sample 168 according to one or more embodiments of the present disclosure.

The method of testing a sample 168 may be implemented using the testing device 106 described with reference to FIGS. 4A-5B. Further, the sample 168 to be tested may be prepared using the method described with reference to FIGS. 1-3B. However, the present disclosure is not limited thereto. For example, the sample 168 may be prepared using any suitable method of extracting paramagnetic materials into an optically clear solution.

In one or more embodiments, the method includes loading the sample 168 into a holder 169 in a cavity enhancement module (S602). The cavity enhancement module may include a first mirror (e.g., a front mirror) 170 and a second mirror (e.g., a back mirror) 172 opposing the front mirror with the sample 168 loaded therebetween. The sample 168 may also be between a first magnet (e.g., a first electromagnet 174) and a second magnet (e.g., a second electromagnet 176) capable of providing an oscillating magnetic field.

The method may further include directing polarized light to the sample (e.g., directing polarized light from a source module 142 to the sample 168 loaded on the holder 169) (S604). During a first period of time, the first magnet and the second magnet may not apply a magnetic field to the sample 168. Accordingly, a first detector (e.g., a first photodetector) 178 and a second detector (e.g., a second photodetector) 180 may sample light from the sample 168 when a magnetic field of the sample module 144 is off (i.e., a magnetic field is not applied to the sample 168 by the first magnet and the second magnet) (S606).

The method may further include determining, by a processing circuit, a first ratio of an intensity of light detected by the first detector 178 to an intensity of light detected by the second detector 180 (S608). The first ratio may be determined based on signals from the detectors while the magnetic field of the sample module 144 is off, and the processing circuit may then normalize transmittance to 100% using the first ratio (S610).

The method may further include, during a second period of time, turning on the magnetic field of the sample module (e.g., applying an oscillating magnetic field to the sample 168 at a desired frequency using the first magnet and the second magnet) 144. Accordingly, the first detector 178 and the second detector 180 may sample light from the sample 168 when the magnetic field of the sample module 144 is on (S612).

As such, the processing circuit may determine a second ratio of an intensity of light detected by the first detector 178 to an intensity of light detected by the second detector 180 (S614). The second ratio may be determined based on signals from the detectors while the magnetic field of the sample module 144 is on, and the processing circuit may then determine a relative change in transmittance based on the first ratio and the second ratio (S616).

In one or more embodiments, the relative change in transmittance may be averaged over for three oscillations or pulses of the magnetic field to obtain a single measurement or value. Therefore, in one or more embodiments, acts S606, S608, S610, S612, S614, and/or S616 may be repeated while the magnetic field is oscillated or pulsed three times to arrive at an averaged relative change in transmittance. However, the present disclosure is not limited thereto and any other suitable form of weighing, averaging, sampling, and/or the like may be used to obtain a single measurement or value.

In one or more embodiments, the relative change in transmittance may be further converted to a concentration (S618) using a standard curve or any other suitable method. In the case of hemozoin and detection of malaria parasites, the method may further include determining levels of parasitemia based on the concentration of hemozoin using any known method.

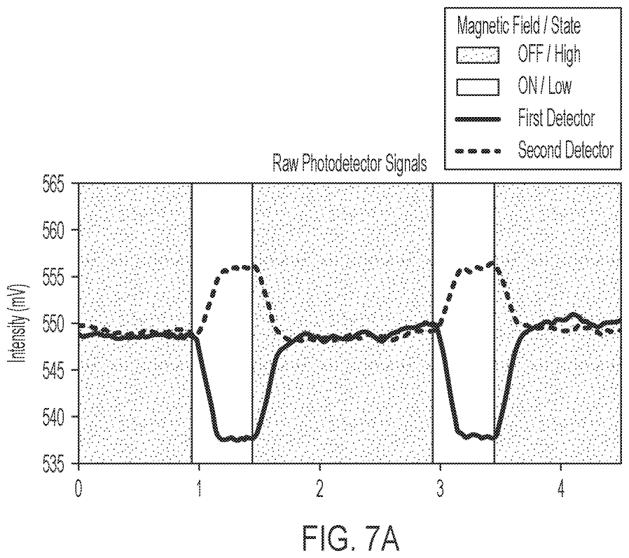

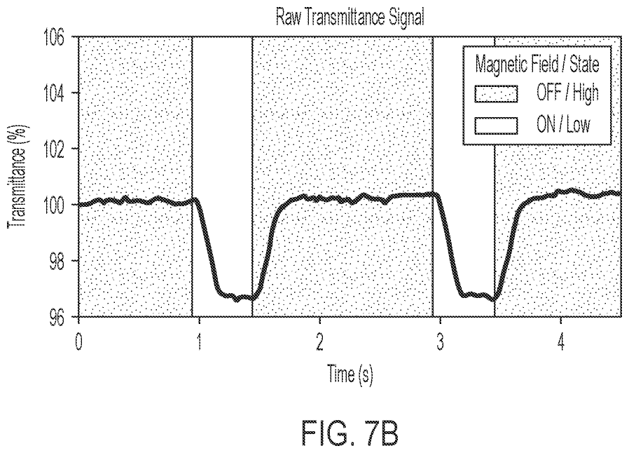

FIG. 7A is a graph illustrating an oscillating magnetic field applied by a magnet (e.g., applied by a pulsing relay for an electromagnet) over time according to one or more embodiments of the present disclosure.

With reference to FIG. 7A, the intensity of the first detector 178 is represented by a solid line and the intensity of the second detector 180 is presented by a dashed line. As shown in FIG. 7A, the magnetic field of the sample module 144 is off from 0 to 1 second, on from 1 to 1.5 seconds, off from 1.5 to 3 seconds, on from 3 seconds to 3.5 seconds, and off from 3.5 seconds to 4.5 seconds. To arrive at the results shown in FIG. 7A, the magnetic field was applied as a pulsed, non-sinusoidal wave with 0.5 second of magnetic field on and 1 seconds of magnetic field off.

As shown in FIG. 7A, signals from the first detector 178 and the second detector 180 are concurrently (e.g., simultaneously) measured while the magnetic field is pulsed on and off. Based on the axis of polarization that is being observed, the intensity will either increase or decrease in the presence of the applied magnetic field. When the magnetic field is off, the ratio of the intensity of the first detector 178 and the second detector 180 may be normalized to 100%. When the magnetic field is on, the intensity of the first detector 178 signal increases and the intensity of the second detector 180 signal decreases. When the magnetic field is subsequently off, the intensity of the first detector 178 signal decreases and the intensity of the second detector 180 signal increases relative to the intensities of the first detector 178 and the second detector 180 when the magnetic field is on.

As previously discussed with reference to FIGS. 4A-4D, the presence of paramagnetic materials may cause transmission of light along a polarization axis to increase (as shown by the increase in the intensity detected by the second detector 180) and transmission of light along another polarization axis (e.g., another polarization axis orthogonal to the polarization axis) to decrease (as shown by the decrease in the intensity detected by the first detector 178).

FIG. 7B is a graph illustrating transmittance over time according to one or more embodiments of the present disclosure.

With reference to FIG. 7B, transmittance may be determined based on the ratio of the intensity of the first detector 178 to the intensity of the second detector 180 shown in FIG. 7A. In this case, when the magnetic field of the sample module 144 is off, the corresponding ratio is normalized as 100% transmittance.

As shown in FIG. 7B, a change in relative transmittance may be determined using any suitable method such as, for example, Equation 1. Based on the determined change in relative transmittance, a standard curve may be used to determine the concentration of paramagnetic materials in the sample 168.

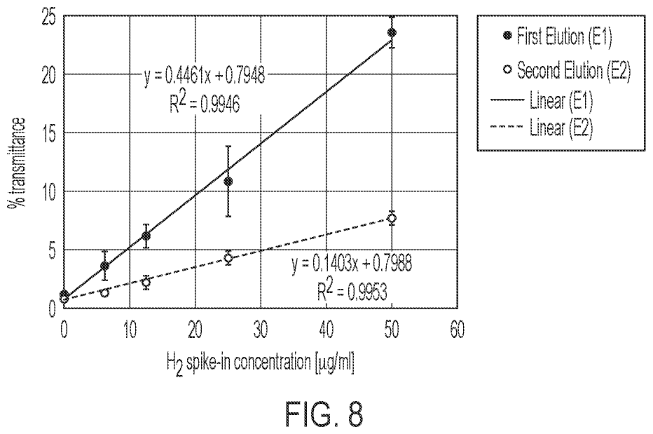

FIG. 8 is a graph illustrating a standard curve for a paramagnetic material in an aqueous medium according to one or more embodiments of the present disclosure.

With reference to FIG. 8, a standard curve was determined by spiking in known concentrations of a paramagnetic material of interest in an aqueous medium. In this case, as a non-limiting example, a negative control of whole blood, hemozoin spike in values of 6.25, 12.5, 25, and 50 μg/mL applied to whole blood, and pure buffer solution were used to produce six test mixtures 108, samples having a volume of less than 500 μL were prepared using the method of FIG. 3B and analyzed using the testing device 106 and method of FIG. 6. Each of the six test samples were further prepared as a first elution and a second elution. In this case, the first elution corresponded to a first purification and extraction of paramagnetic materials from the aqueous medium and the second elution corresponds to a second purification and extraction of remaining paramagnetic materials from the remaining aqueous medium. Further, this experiment was performed in triplicate.

The buffer solution test sample resulted in a relative change in transmittance value of 0.49 for both the first elution and the second elution. The whole blood test sample resulted in a relative change in transmittance value of 1.28 and 1.02 for the first elution and the second elution, respectively. The 6.25 μg/mL hemozoin test sample resulted in a relative change in transmittance value of 3.74 and 1.44 for the first elution and the second elution, respectively. The 12.5 μg/mL hemozoin test sample resulted in a relative change in transmittance value of 6.25 and 2.43 for the first elution and the second elution, respectively. The 25 μg/mL hemozoin test sample resulted in a relative change in transmittance value of 10.89 and 4.46 for the first elution and the second elution, respectively. The 50 μg/mL hemozoin test sample resulted in a relative change in transmittance value of 23.64 and 7.80 for the first elution and the second elution, respectively.

As shown in FIG. 8, the change in relative transmittance may be plotted on a linear scale to show linear correlation. Based on the standard curve illustrated in FIG. 8 the concentration of paramagnetic materials (e.g., hemozoin) in an aqueous medium (e.g., whole blood) may be determined from the change in transmittance determined using the method of FIG. 6.

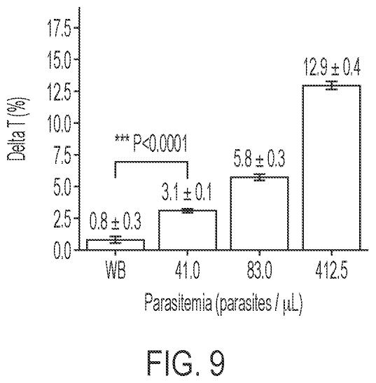

FIG. 9 is a graph illustrating change in transmittance converted to parasitemia levels according to one or more embodiments of the present disclosure.

With reference to FIG. 9, the resulting change in relative transmittance determined for the hemozoin spike in values of 6.25, 12.5, 25, and 50 μg/mL applied to whole blood were converted to parasites/μL using known conversion methods. As shown in FIG. 9, sensitivity as high as 10-40 malaria parasites per microliter may be achieved.

Accordingly, as disclosed herein, one or more embodiments of the present disclosure provide a system and method of extracting paramagnetic materials from an aqueous medium and determining the presence and concentration of the paramagnetic materials in the aqueous medium.

While various methods according to some embodiments of the present disclosure has been described according to various processes having a certain process order, the present disclosure is not limited thereto. For example, when a certain embodiment may be implemented differently, a specific process order may be different from the described order. For example, two consecutively described processes may be performed at the same or substantially at the same time, or may be performed in an order opposite to the described order.

It will be understood that, although the terms “first,” “second,” “third,” etc., may be used herein to describe various elements, components, regions, and/or sections, these elements, components, regions, and/or sections should not be limited by these terms. These terms are used to distinguish one element, component, region, layer or section from another element, component, region, or section. Thus, a first element, component, region, or section described below could be termed a second element, component, region, or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B.

Further, the use of “may” when describing embodiments of the present disclosure refers to “some embodiments of the present disclosure.” As used herein, the terms “use,” “using,” and “used” may be considered synonymous with the terms “utilize,” “utilizing,” and “utilized,” respectively.

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and refers to within an acceptable range of deviation for the particular value as determined by one of ordinary skill in the art, considering the measurement in question and the error associated with measurement of the particular quantity (i.e., the limitations of the measurement system).

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Although some example embodiments have been described, those skilled in the art will readily appreciate that various modifications are possible in the example embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific example embodiments disclosed herein, and that various modifications to the disclosed example embodiments, as well as other example embodiments, are intended to be included within the spirit and scope of the present disclosure as defined in the appended claims, and their equivalents.

1. A method of detecting paramagnetic material in an aqueous medium, the method comprising:
loading a sample into a holder in a cavity enhancement module;
directing light from a light source to the sample in the holder;
applying an oscillating magnetic field to the sample in the holder;
determining a first level of transmittance with the oscillating magnetic field in a first state;
changing a state of the oscillating magnetic field from the first state to a second state;
determining a second level of transmittance with the oscillating magnetic field in the second state; and
determining a change in transmittance of the light from the sample based on the first level of transmittance and the second level of transmittance.

2. The method of claim 1, wherein the holder is between a first magnet and a second magnet configured to apply the oscillating magnetic field, and
wherein the oscillating magnetic field is a pulsed magnetic field at a fixed frequency.

3. The method of claim 1, wherein the cavity enhancement module comprises a first mirror and a second mirror at opposite sides of the holder.

4. The method of claim 1, further comprising:
sampling, by a first detector, an intensity of light polarized along a first polarization axis transmitted through the sample; and
sampling, by a second detector, an intensity of light polarized along a second polarization axis transmitted through the sample.

5. The method of claim 4, wherein the determining the change in transmittance further comprises determining a ratio of the intensity sampled by the first detector to the intensity sampled by the second detector.

6. The method of claim 5, further comprising normalizing the transmittance to 100% utilizing the ratio when the oscillating magnetic field is in the first state.

7. The method of claim 5, wherein the change in transmittance is based on a change in the ratio between the first state of the oscillating magnetic field and the second state of the oscillating magnetic field.

8. The method of claim 7, the method further comprising determining a concentration of a paramagnetic material based on the change in transmittance.

9. A method of extracting and detecting paramagnetic material in an aqueous medium, the method comprising:
while applying a magnetic field to a column containing a metal mesh:
loading a sample mixture into the column; and
washing the column with a washing buffer;
removing the magnetic field applied to the column;
eluting a sample out of the column using an elution buffer;
loading the sample into a holder in a cavity enhancement module;
directing light from a light source to the sample in the holder;
applying an oscillating magnetic field to the sample in the holder;
determining a first level of transmittance with the oscillating magnetic field in a first state;
changing a state of the oscillating magnetic field from the first state to a second state;
determining a second level of transmittance with the oscillating magnetic field in the second state; and
determining a change in transmittance of the light from the sample based on the first level of transmittance and the second level of transmittance.

10. The method of claim 9, wherein the washing the column further comprises washing the column with a paramagnetic blocking agent.

11. A system to detect paramagnetic material in an aqueous medium, the system comprising:
a holder in a cavity enhancement module, the holder being configured to receive a sample;
a light source to emit light toward the sample in the holder;
a magnet to apply an oscillating magnetic field to the sample in the holder, the oscillating magnetic field having a first state and a second state; and
a processing circuit to determine a change in transmittance based on light from the sample.

12. The system of claim 11, wherein the magnet comprises a first magnet and a second magnet configured to apply the oscillating magnetic field.

13. The system of claim 12, wherein the oscillating magnetic field is a pulsed magnetic field at a fixed frequency.

14. The system of claim 11, wherein the cavity enhancement module comprises a first mirror and a second mirror at opposite sides of the holder.

15. The system of claim 11, the system further comprising:
a first detector to sample an intensity of light polarized along a first polarization axis transmitted through the sample; and
a second detector to sample an intensity of light polarized along a second polarization axis transmitted through the sample.

16. The system of claim 15, wherein the processing circuit is configured to determine a ratio of the intensity sampled by the first detector to the intensity sampled by the second detector.

17. The system of claim 16, wherein the processing circuit is configured to normalize the transmittance to 100% utilizing the ratio when the oscillating magnetic field is in the first state.

18. The system of claim 16, wherein the change in transmittance is based on a change in the ratio between the first state of the oscillating magnetic field and the second state of the oscillating magnetic field.

19. The system of claim 18, wherein the processing circuit is configured to determine a concentration of a paramagnetic material based on the change in transmittance.

20. The system of claim 19, the system further comprising:
a column containing a metal mesh, the column being configured to receive a sample mixture; and
a column magnet to selectively apply a magnetic field to the column, the column magnet being adjacent to the column.
